(19) United States
(12) Patent Application Publication
(10) Pub. No.: US 2022/0198818 A1
(43) Pub. Date: Jun. 23, 2022

(54) UNDER-DISPLAY IMAGE ACQUISITION STRUCTURE AND ELECTRONIC DEVICE

(71) Applicant: SHANGHAI HARVEST INTELLIGENCE TECHNOLOGY CO., LTD., Shanghai (CN)

(72) Inventor: Zongwen CHEN, Shanghai (CN)

(73) Assignee: SHANGHAI HARVEST INTELLIGENCE TECHNOLOGY CO., LTD., Shanghai (CN)

(21) Appl. No.: 17/275,586

(22) PCT Filed: Jul. 3, 2019
(86) PCT No.: PCT/CN2019/094572

§ 371 Date: Feb. 22, 2022

(30) Foreign Application Priority Data
Sep. 12, 2018 (CN) 201811062585.4

(51) Int. Cl. G06V 40/13

(52) U.S. Cl. CPC G06V 40/1318

(57) ABSTRACT

The present invention publishes an under-display image acquisition structure and an electronic device, including a light-permeable cover plate, a light source plate and a light sensor. The light source plate and the light sensor are disposed under the light-permeable cover plate. The light-permeable cover plate has a light-permeable area beyond an edge of the light sensor. The light source plate has a light source area beyond an edge of the light sensor in the direction of the light-permeable area. Light from light sources in the light source area is directed onto the light sensor after being totally reflected by the light-permeable cover plate. Distinguishable from the prior art, the above technical solution utilizes the optical total reflection principle so that image data outside the range of the light sensor can be captured by the light sensor. The effective imaging area of the small size imaging sensor is increased so that the area of the fingerprint to be imaged exceeds the area of the sensor, thereby enabling effective use of image information of lens-free imaging.

### TECHNICAL FIELD

The present invention relates to a technical field of under-display image imaging, and more particularly to an under-display image acquisition structure and an electronic device.

### BACKGROUND ART

With the development of information technology, biometric identification technology plays an increasingly important role in guaranteeing information security, wherein fingerprint recognition has become one of the key technical means for identity identification and device unlocking that are widely used in the filed of mobile Internet. Under the trend of increasing screen-to-body ratio of devices, conventional capacitive fingerprint recognition can no longer meet the demand, while ultrasonic fingerprint recognition has issues of technical maturity and cost. Optical fingerprint recognition is expected to become the mainstream technical solution for under-display fingerprint recognition.

The existing optical fingerprint recognition solution is based on the geometric optical lens imaging principle, and the fingerprint module used includes microlens array, optical spatial filter and other components, which have many drawbacks such as complex structure, thick module, small sensing range and high cost. The lens-free under-display optical fingerprint recognition, which is realized by the total reflection imaging principle of physical optics, has the advantages of simple structure, thin module, large sensing range and low cost compared with the existing optical fingerprint solution. The imaging area of current under-display optical imaging is generally smaller than the sensor area. Therefore, in order to obtain a larger imaging area, a larger sensor is required, which will crowd the under-display space.

### Content of Invention

Accordingly, it is required to provide an under-display image acquisition structure and an electronic device to solve the technical problem of “in order to obtain a larger imaging area, a larger sensor is required, which will crowd the under-display space”.

To achieve the aforesaid purpose, the inventor provides an under-display image acquisition structure including a light-permeable cover plate, a light source plate and a light sensor. The light source plate and the light sensor are disposed under the light-permeable cover plate. The light-permeable cover plate has a light-permeable area beyond an edge of the light sensor. The light source plate has a light source area beyond an edge of the light sensor in the direction of the light-permeable area. Light from a light source in the light source area is directed onto the light sensor after being totally reflected by the light-permeable cover plate.

Further, the light source area is beyond an edge of the light-permeable cover plate.

Further, the light source plate is disposed above the light sensor.

Further, the light sensor plane includes right angles. The light source area of the light source plate is arc-shaped at the right angles.

Further, a distance between the light source of the light source plate and a normal line where the light source is incident on the light-permeable cover plate at a critical angle is denoted as d. The distance D between an edge of the light source area and the edge of the light sensor is greater than the distance d.

Further, the edge of the light-permeable area and the edge of the light sensor is D-d.

Further, the light source plate is a display panel.

Further, the display panel is a liquid crystal display, an active matrix organic light-emitting diode display, or a micro-light-emitting diode display.

Further, the light-permeable area or the light source area surrounds the outer circumference of the light sensor.

The present invention provides an electronic device including a processor and an image acquisition structure connected to the processor. The image acquisition structure is an under-display image acquisition structure mentioned above.

Differing from the prior art, the above-mentioned technical solution uses the principle of optical total reflection to enable image data outside the range of the light sensor to be captured by the light sensor. Increasing the effective imaging area of the small size imaging sensor allows the area of the fingerprint being imaged to exceed the area of the sensor, thus enabling effective use of image information from lens-free imaging. In this way, the light sensor area can be reduced to avoid taking up too much space under the display.

### BRIEF DESCRIPTION OF DRAWINGS

FIG. 1 is a schematic diagram of using the total reflection imaging principle to achieve lens-free under-display optical fingerprint imaging;

FIG. 2 is a schematic diagram of an under-display image imaging structure and imaging for a specific implementation of an embodiment of the present invention;

FIG. 3 is a schematic diagram of the structure of a light sensor and a light source plate of an embodiment; and

FIG. 4 is a schematic diagram of a light sensor and a fingerprint image captured by a light-permeable panel of an embodiment.

Descriptions of figure labels:

| | |
|---|---|
| O: light-emitting point | A: contact point of light-emitting |
| | point and light-permeable cover plate |
| B, C: imaging points | X: normal line |
| 1. light-permeable area | 2. light source area |
| 3. light sensor | 4. light source plate |
| 5. fingerprint image on | |
| light-permeable cover plate | |

### EMBODYING MANNER

In order to explain in detail the technical content, construction features, and achieved purpose and effect of the technical solutions, a thorough explanation is made in the following in combination with specific embodiments and in corporation with attached drawings.

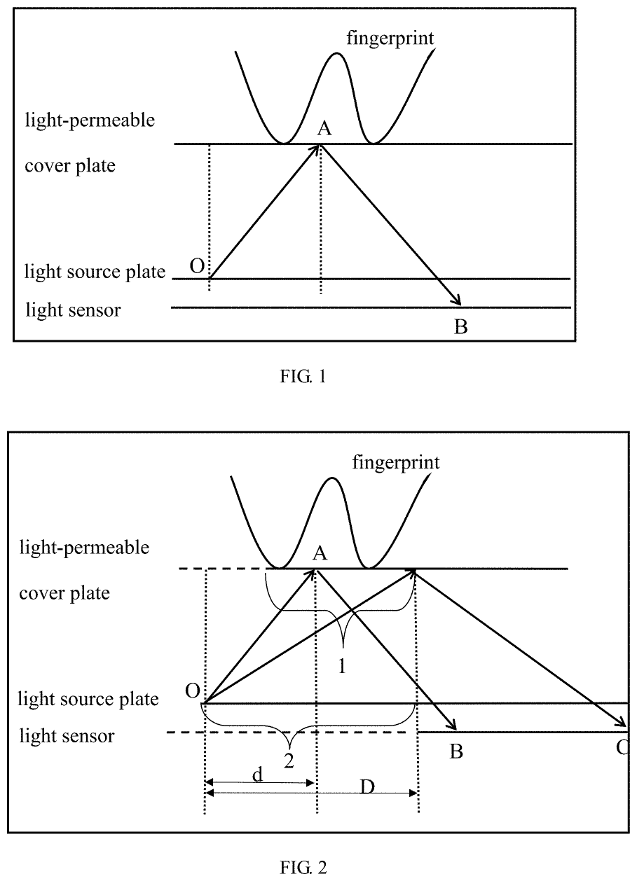

Referring to FIG. 1 to FIG. 4, this embodiment provides an under-display image acquisition structure which is an improvement of under-display image acquisition structures. An under-display image acquisition structure before the improvement is shown in FIG. 1. An under-display image imaging structure includes a light-permeable cover plate, a light source plate and a light sensor. The light source plate and the light sensor are disposed under the light-permeable cover plate. Preferably, the light-permeable cover plate, the light source plate and the light sensor are disposed in parallel. The light source plate is a plate disposed with a plurality of light sources. The light-permeable cover plate may be a single-layer plate structure or a multi-layer structure. The single-layer structure may be a glass cover plate or an organic light-permeable material cover plate. The single-layer cover plate may also be a cover plate having other functions, such as a touch screen. The multi-layer structure may be a multi-layer glass cover plate, a multi-layer organic light-permeable material cover plate, or a combination of a glass cover plate and an organic light-permeable material cover plate. The light sensor is used to obtain light, includes a plurality of photosensitive units, and may be disposed under the light source plate alone or disposed on the light source plate. When the light sensor is disposed under the light source plate, light is able to enter the light sensor through gaps among the light sources on the light source plate. When the light sensor is disposed on the light source plate, the photosensitive units may be disposed in the gaps among the light sources (pixel dots) of the light source plate. The sensor may be disposed in the under-display image imaging structure for acquiring under-display images, e.g., for acquiring fingerprints, palm prints, etc. The light-permeable cover plate and the light source plate need to be filled with optical adhesive for connection and to prevent air from affecting the reflection of light. A refractive index of the optical adhesive should be close to a refractive index of the light-permeable cover plate to avoid total reflection of light between the optical adhesive and the light-permeable cover plate.

The principle of total reflection imaging is that during imaging, the finger is in contact with the light-permeable cover plate, and due to the air in fingerprint valleys, light having an incident angle that exceeds a critical angle of total reflection will cause total reflection, so the light sensor will collect bright light. For fingerprint ridges in contact with an upper surface of the light-permeable cover plate, light will not result in total reflection, and the light sensor will then collect darker light, so a fingerprint image can be determined. During imaging, as shown in FIG. 1, the finger is pressed onto a point A on the glass cover plate (Cover glass), and light from the light sources on the light source plate is imaged onto a point B on a sensor surface through total reflection on the upper surface of the light-permeable cover plate. The fingerprint image at the point A can be acquired according to the light data collected from the point B.

The under-display image acquisition structure of super imaging of this embodiment is illustrated in FIG. 2, and includes a light-permeable cover plate, a light source plate and a light sensor. The light source plate and the light sensor are disposed under the light-permeable cover plate. The light-permeable cover plate has a light-permeable area 1 beyond an edge of the light sensor. The light source plate has a light source area 2 beyond an edge of the light sensor in the direction of the light-permeable area. Light from light sources in the light source area is directed onto the light sensor after being totally reflected by the light-permeable cover plate. During imaging, light O from the light source area 2 can enter the light-permeable area 1 and is totally reflected to the light sensor. Although there is no light sensor below the fingerprint at the point A on the light-permeable cover plate, the light sensor can still obtain image information of A. In this way, the fingerprint image 5 thus captured will be larger than a limits of the light sensor 3, as shown in FIG. 4. That is, in a projection direction that is vertical to the light-permeable cover plate, the light-permeable area 1 is beyond a plane where the light sensor is located, so the light sensor can acquire a fingerprint image that is larger than an area of the light sensor. In this way, when acquiring fingerprint images of the same area, this embodiment can use a light sensor of a smaller area, saving the space under the light source plate.

This application does not limit the size of the light-permeable cover plate, as long as the light-permeable cover plate has an area beyond the edge of the light sensor. For example, the light-permeable cover plate can be the same size as the light source plate, i.e., the light-permeable area 1 is the same size as the light source area 2. However, the fingerprint image cannot be obtained because total reflection cannot occur in partial areas of such light-permeable area 1 (e.g., the edges), which also causes waste of the light-permeable cover plate. In some embodiments, the size of the light source plate is larger than the light-permeable cover plate, that is, the light source area is beyond the edge of the light-permeable cover plate, i.e., a portion of the light source area projected perpendicular to the light-permeable cover plate is outside the light-permeable area 1.

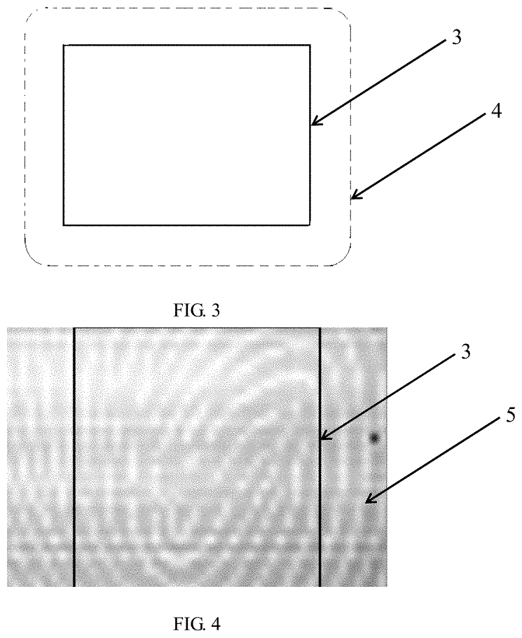

This application does not limit a shape of the light sensor, which can be round or square, etc. When the light sensor is square, as shown in FIG. 3, the light sensor 3 plane includes right angles. In order for the light source from the light source plate to enter the light sensor through the total reflection by the light-permeable cover plate, the light source area of the light source plate 4 is arc-shaped at the right angles.

In order for a light source of the light source area to form a total reflection on the light-permeable area, a distance between the light source of the light source plate and a normal line X where the light source is incident on the light-permeable cover plate at a critical angle is first denoted as d. Then, the distance D between the edge of the light source area and the edge of the light sensor is greater than the distance d. The critical angle is an angle of incidence at which total reflection of incident light just incurs [sic: occurs] on the light-permeable cover plate, and total reflection will not incur [sic: occur] to the incident light smaller than the critical angle. The normal line X is a straight line that is perpendicular to the light-permeable cover plate and that has a foot of the perpendicular which is an intersection of light at the critical angle and the upper surface of the light-permeable cover plate. For a light-permeable cover plate having a uniform material and a light source plate whose relative position is determined, the distance d is fixed. The distance D is a distance between an edge of a side of the light source area away from the light sensor and an edge of a side of the light sensor near the light source area, as projected in a direction perpendicular to the light-permeable panel. When the distance D is greater than the distance d, the light from the light source in the light source area having a distance greater than d will form a total reflection on the light-permeable area, so the fingerprint image can be obtained on the light-permeable area. Since the light-permeable area 1, when projected in the direction perpendicular to the light-permeable cover plate, is beyond the plane where the light sensor is located, the light sensor is able to acquire the fingerprint image that is larger than the area of the light sensor. When the light sensor has a right angle, for a preferable light source area, a radius of the arc-shape around the right angle is the distance D.

A distance between the edge of an area in the light-permeable area where total reflection can occur and the edge of the light sensor is D-d. The preferable distance between the edge of the light-permeable area and the edge of the light sensor is thus D-d, so total reflection can occur on [sic] the light-permeable area for all the light sources, and thus the whole fingerprint image on the light-permeable area can be obtained.

Although in theory, the fingerprint imaging of total reflection may have no maximum distance limitation, i.e., the distance D can be infinitely large, in practice, due to the limitation of the internal structure of the light source plate, when the angle of reflection increases to a certain degree, the totally reflected light will be blocked by lateral surfaces of the light sources and cannot enter the light sensor through the gaps among the light sources. Therefore, there exists a maximum value of a horizontal distance for total reflection imaging with single point light source illumination, as shown by an imaging point C in FIG. 3. This value can be obtained through experimentation.

In a specific embodiment, assuming that the size of the sensor is a square of size K×K (where K is the sensor side length), when 4(D−d)<K is satisfied, the fingerprint outside the light sensor can theoretically be projected onto the sensor using the principle of time-sharing multiplexing, and using different light sources on the light source plate to light up for illumination. The imaging area on the light-permeable cover plate can be expanded to be about the size of (K+D−d)², with circles of radius D at the four corners, as shown in FIG. 3. A light source point array can image a fingerprint in an area as far as D onto the light sensor; in order to obtain fingerprint information with an area of approximately (K+D−d)², the light source point array on the light source plate needs to be designed with an annular area. At this point, the outermost point array spacing is about 0.5D, the center of the lit-up spot is about 2d from the sensor boundary, and the light-permeable cover plate area corresponding to the four corners of the light sensor would appear to be semicircles with radii of about 2d. At this point, the image on the light-permeable cover plate beyond the sensor can be imaged on the sensor, realizing external super imaging. The imaging inside the sensor also follows the aforementioned super imaging principle. When the light source points on the light source plate are driven to light up, the bright spots are designed to have a distance of d away from the sensor boundary, to scan with a spacing size of 0.5D, and to progressively shrink inward with a spacing of d. In this way, the whole fingerprint can be scanned, as shown in FIG. 3. That is, in a certain embodiment, the light sources on the light source plate may be arranged with a lateral spacing of d and a longitudinal spacing of 0.5D. At this point, the longitudinal direction is the same as the edge of the light sensor and the lateral direction is perpendicular to the edge of the light sensor.

The invention does not limit the form of the light source on the light source plate; if the point is simply to obtain fingerprints, the light source can be a light source purely for the purpose of under-display image acquisition, such as a pure color LED light source, or alternatively be a display panel. The display panel contains a plurality of pixel dots for display, and can display different images by driving on/off and colors of different pixel dots. The display panel includes a liquid crystal display (LCD), an active matrix organic light-emitting diode (AMOLED) display, or a micro-light-emitting diode (micro-LED) display, all of which use a thin-film transistor (TFT) structure to scan and drive a single pixel, allowing for single driving of a pixel dot. That is, it is possible to realize driving of point light sources and array display of multiple point light sources. Meanwhile, light can pass through the gaps among the pixel dots and enter the light sensor.

The present invention does not limit the forms of distribution of the light-permeable area or the light source area, and the light-permeable area may be on only one side or both sides of the light sensor (as shown in FIG. 4). Alternatively, in some embodiments, as shown in FIG. 3, the light-permeable area or the light source area surrounds the outer circumference of the light sensor so as to expand the acquisition area of fingerprints on the light-permeable cover plate as much as possible.

The present invention provides an electronic device including a processor and an image acquisition structure connected to the processor, and the image acquisition structure is an under-display image acquisition structure as described above. Such an electronic device, after driving the light source plate by the processor, can capture the surface image of the light-permeable cover plate on the light sensor, and only a smaller sensor size is required, which can reduce the space occupation of the sensor under the light source plate and free up more space for the existing electronic devices. Such space can be used by batteries, which can extend the battery life of electronic devices.

It should be noted that although each of the above embodiments has been described herein, it does not thereby limit the scope of patent protection of the present invention. Therefore, based on the innovative concept of the present invention, changes and modifications to the embodiments described herein, or equivalent structures or equivalent process changes made by using the contents of the specification of the present invention and the accompanying drawings, or directly or indirectly applying the above technical solutions in other related technical fields, are all included within the scope of patent protection of the present invention.

1. An under-display image acquisition structure characterized by including a light-permeable cover plate, a light source plate and a light sensor, the light source plate and the light sensor disposed under the light-permeable cover plate, the light-permeable cover plate having a light-permeable area beyond an edge of the light sensor, the light source plate having a light source area beyond an edge of the light sensor in the direction of the light-permeable area, light from a light source in the light source area being directed onto the light sensor after being totally reflected by the light-permeable cover plate.

2. An under-display image acquisition structure as claimed in claim 1, characterized in that:
the light source area is beyond an edge of the light-permeable cover plate.

3. An under-display image acquisition structure as claimed in claim 1, characterized in that:
the light source plate is disposed above the light sensor.

4. An under-display image acquisition structure as claimed in claim 1, characterized in that: the light sensor plane includes right angles, the light source area of the light source plate being arc-shaped at the right angles.

5. An under-display image acquisition structure as claimed in claim 1, characterized in that:
a distance between the light source of the light source plate and a normal line where the light source is incident on the light-permeable cover plate at a critical angle is denoted as d,
the distance D between an edge of the light source area and the edge of the light sensor being greater than the distance d.

6. An under-display image acquisition structure as claimed in claim 5, characterized in that:
the edge of the light-permeable area and the edge of the light sensor is D−d.

7. An under-display image acquisition structure as claimed in claim 1, characterized in that:
the light source plate is a display panel.

8. An under-display image acquisition structure as claimed in claim 7, characterized in that:
the display panel is a liquid crystal display, an active matrix organic light-emitting diode display, or a micro-light-emitting diode display.

9. An under-display image acquisition structure as claimed in claim 1, characterized in that:
the light-permeable area or the light source area surrounds the outer circumference of the light sensor.

10. An electronic device characterized by: including a processor and an image acquisition structure connected to the processor, the image acquisition structure being an under-display image acquisition structure as claimed in claim 1.

11. An electronic device characterized by: including a processor and an image acquisition structure connected to the processor, the image acquisition structure being an under-display image acquisition structure as claimed in claim 2.

12. An electronic device characterized by: including a processor and an image acquisition structure connected to the processor, the image acquisition structure being an under-display image acquisition structure as claimed in claim 3.

13. An electronic device characterized by: including a processor and an image acquisition structure connected to the processor, the image acquisition structure being an under-display image acquisition structure as claimed in claim 4.

14. An electronic device characterized by: including a processor and an image acquisition structure connected to the processor, the image acquisition structure being an under-display image acquisition structure as claimed in claim 5.

15. An electronic device characterized by: including a processor and an image acquisition structure connected to the processor, the image acquisition structure being an under-display image acquisition structure as claimed in claim 6.

16. An electronic device characterized by: including a processor and an image acquisition structure connected to the processor, the image acquisition structure being an under-display image acquisition structure as claimed in claim 7.

17. An electronic device characterized by: including a processor and an image acquisition structure connected to the processor, the image acquisition structure being an under-display image acquisition structure as claimed in claim 8.

18. An electronic device characterized by: including a processor and an image acquisition structure connected to the processor, the image acquisition structure being an under-display image acquisition structure as claimed in claim 9.
